(19) United States
(12) Patent Application Publication
(10) Pub. No.: US 2012/0178330 A1
(43) Pub. Date: Jul. 12, 2012

(54) PAPERMAKERS' FORMING FABRIC INCLUDING PAIRS OF MACHINE SIDE COMPLEMENTARY YARNS

(75) Inventor: Richard Stone, Carleton Place (CA)

(73) Assignee: ASTENJOHNSON, INC., CHARLESTON, SC (US)

(21) Appl. No.: 13/496,514

(22) PCT Filed: Sep. 29, 2010
(86) PCT No.: PCT/CA2010/001546

§ 371 Date: Mar. 16, 2012

(30) Foreign Application Priority Data
Sep. 29, 2009 (CA) 2680924

(51) Int. Cl. B32B 21/10; D03D 15/00

(52) U.S. Cl. 442/295; 442/199

(57) ABSTRACT

A multilayer woven industrial fabric comprises at least two layers of weft yarns interwoven with at least one system of warp yarns. At least some of the machine side (MS) weft yarns are arranged as complementary pairs, such that for each pair, the members follow mutually complementary paths, and exchange positions with each other so that, in the MS surface, the path of a pair of weft yarns appears to be that of a single yarn. The complementary weft yarns interweave only with the MS warp yarns and do not appear in the paper side. The unique MS weft yarn arrangement allows for the use of smaller yarns, while increasing fabric stiffness and dimensional stability, and is applicable to any multi-layer fabric design which includes at least two layers of weft yarns and one system of warp yarns.

### FIELD OF THE INVENTION

The present invention relates to fabrics intended for use in industrial filtration processes, and is particularly concerned with papermakers forming fabrics which are used to drain and form a paper web in the forming section of papermaking machines. Although the invention is described below primarily in relation to papermakers fabrics, the invention is applicable to industrial filtration and similar processes which require fabrics having similar general properties to papermakers fabrics.

### BACKGROUND OF THE INVENTION

In modern high speed papermaking processes, a highly aqueous stock consisting of about 99% water and 1% papermaking solids is ejected at high speed and precision onto an endless moving forming fabric. A nascent web, which will be self coherent and consist of about 25% papermaking solids by the end of the forming section, is formed as the stock is drained through the fabric. This web is then transferred from the forming fabric into the press section where, together with at least one press fabric, it passes through one or more nips where additional fluid is removed by mechanical means. The web is then transferred into the dryer section of the papermaking machine where much of the remaining moisture is removed by evaporative means, the web being supported on one or more dryer fabrics as it is heated, for example by being passed in serpentine fashion over a series of heated rotating drums. The finished sheet is then reeled into large rolls at the end of the papermaking machine, and further finishing processes may be applied.

Forming fabrics are critical to the quality of the paper product that is ultimately produced on the papermaking machine. In simplest terms, these fabrics are designed to allow fluid from the stock to drain through the fabric in a controlled manner, while providing uniform support to the papermaking solids. The fabrics must also be very robust and dimensionally stable so as to survive the environmental forces to which they are exposed. In addition, the fabrics should be as thin as is possible, so as to minimize internal void volume and water carrying capacity. Considerable efforts have been made by various manufacturers of papermaking fabrics to decrease the thickness (or caliper) of their fabrics so as to minimize this interior void volume while, at the same time, maximizing fiber support.

The papermaking surfaces of modern forming fabrics are finely woven structures formed using very small diameter monofilament yarns in order to provide this requisite support for the papermaking components while allowing adequate fluid drainage. On its own, a fine woven structure would generally not be usable in a high speed papermaking process as it would lack sufficient mechanical stability and stiffness while in operation, thus causing problems such as fabric creasing and poor fabric guiding. It would also be difficult to provide a seam of sufficient strength to reliably join the fabric ends while in use on the machine; other mechanical issues, especially relating to wear, would also occur due to the small yarn size and fabric structure employed. By comparison, coarse mesh fabrics which employ relatively larger diameter yarns generally provide adequate stability and wear life while sacrificing good formation. Selection of an appropriate fabric design, mesh and yarn size by the fabric manufacturer for a given application usually represents a balance between desirable papermaking qualities (e.g. formation and drainage) and the structural properties of the fabric (e.g. stiffness and caliper).

To minimize this trade-off between sheet support and fabric stability, a variety of fabric structures have been developed over time. A comprehensive listing and description of these structures is provided by R. Danby and J. Perrault in Weaves of Papermaking Wires and Forming Fabrics, Pulp & Paper Technical Association of Canada [PAPTAC] Data Sheet G-18, Revised July 2009, a copy of which is incorporated here by reference. This Data Sheet G-18 lists the following forming fabric structures as those which are in current use:

Single layer designs—fabrics woven using one warp yarn system and one weft yarn system.

Semi Duplex or Extra Support Single Layer designs—fabrics woven using one warp yarn system and two weft yarn systems in which the weft yarns are not located directly over each other.

Double layer or Duplex—fabrics woven using one warp yarn system and two weft yarn systems in which the weft yarns of the two systems are usually vertically stacked directly over one another.

Extra Support Double Layer—double layer fabrics with additional weft yarns woven into one layer, usually the top papermaking surface.

Triple Weft—fabrics woven using one warp yarn system and three systems of weft yarns in which the weft are usually stacked vertically one over the other.

Standard Triple layer—fabrics woven using two warp yarn systems and two weft yarn systems to provide two independent fabric structures (top and bottom) that are stitched together during weaving, in the majority of cases using an extra weft yarn system.

Triple Layer Sheet Support Binder (SSB) or Intrinsic Weft or Paired Binders—fabrics woven using two warp and two weft (CD) yarn systems, in which a selected number of the weft yarns are woven into the fabric as interchanging pairs of intrinsic binder yarns. In these arrangements, when one yarn of the pair is being woven into a first fabric surface, the second yarn of the pair is being woven into the second fabric surface. These yarns then exchange positions within one repeat of the weave thereby providing an unbroken, continuous repeat of the weave in both surfaces, and tie the two surfaces together.

Triple Layer “Warp Tie”—fabrics woven using two weft yarn systems and two warp yarn systems in which at least a portion of the warp yarns are woven as interchanging pairs so that, as one yarn of the pair is woven into the first fabric surface, the other is woven into the second. In certain designs, some of the warp yarns of each of the two systems will be interwoven exclusively with weft yarns of one of either the first or second systems of weft yarns.

Triple Layer (WISS) Warp Integrated Sheet Support Binders—fabrics woven using two weft yarn systems and two warp (MD) yarn systems in which all (100%) of the warp yarns are woven as interchanging pairs, so that as one yarn of the pair is being woven into the first surface, the other yarn of the pair is woven into the second. In these fabrics, all of the warp yarns function to bind the surfaces together as well as to contribute to the woven structure of those surfaces.

The features of the present invention can advantageously be applied to each of the above described fabric structures, with the exception of single layer fabrics. The invention finds particular utility when applied in triple layer sheet support binder (SSB) fabrics, triple layer “warp tie” fabrics, and triple layer warp integrated sheet support (WISS) binder type fabrics.

A characteristic common to the fabric structures for which the present invention is applicable is that they include at least two layers or systems of weft yarns. This feature allows for each of the two fabric surfaces to be woven to differing fabric designs using differing materials. The fabric surfaces may be tied together using binder yarns which are part of the weave design in the manner described above; and if so, the binder yarns may be warp yarns or weft yarns. These fabrics are capable of providing high levels of fiber support and good mechanical stability and wear life.

### DISCUSSION OF THE PRIOR ART

As noted above, the forming fabric is installed on the papermaking machine as a continuous belt which is driven through the forming section at high speeds. Accordingly, the fabric must possess good mechanical stability, in particular cross-machine direction (CD) stability, in order to survive the rigors of the forming section environment. This problem has been recognized and addressed by various means in the past.

For example, one means of increasing CD fabric stability is to add additional weft yarns to the structure to create a triple weft fabric. Such fabrics are described in U.S. Pat. No. 4,379,735 (MacBean), U.S. Pat. No. 4,941,514 (Taipale), U.S. Pat. No. 5,164,249 (Tyler et al.), and U.S. Pat. No. 5,169,709 (Fleischer). Other similar structures are known and used. However, a problem associated with triple weft structures is that they are relatively thick, which increases fabric caliper and void volume. This increased thickness in comparison to other fabric designs adversely affects vacuum efficiency, and the water carried by these fabrics may also spot the sheet.

U.S. Pat. No. 6,902,652 (Martin) discloses a warp tie forming fabric with additional cross-machine direction (CD) packing yarns and paired intrinsic warp binder yarns. The CD packing yarns are additional weft yarns that are inserted between adjacent machine side (MS) weft yarns in the fabric weave. The packing yarns reduce the void volume on the machine side of the fabric without significantly disrupting the air permeability or increasing fabric caliper. The placement of the packing yarns also adds to the CD stability and seam strength of the fabric and reduces the lateral movement of the MS weft yarns.

U.S. Pat. No. 6,810,917 (Stone) discloses a forming fabric the PS and MS layers of which are interconnected by pairs of MS intrinsic weft binder yarns. Each of the binder yarn pair members in sequence interlaces with a portion of the MS warp yarns so as to complete an unbroken weft path in the MS weave pattern, and to provide an internal MS float. Each of the binder yarn pair members also interweaves with a PS warp yarn so as to bind the PS and MS layers together.

U.S. Pat. No. 7,637,291 (Boeck) discloses a forming fabric in which the MS layer is formed by binder weft yarns arranged as pairs; each pair is flanked by one non-binding MS weft yarn. WO 05/017254 (Hay et al.) discloses an intrinsic weft binder SSB type forming fabric having separate sets of MS and PS warp and weft interlaced by pairs of intrinsic weft binder yarns, the pair members forming a continuous PS weft path. One of the intrinsic weft binder pair members does not interlace with the MS warp and instead floats between the MS and PS layers before re-entering the PS layer to continue the PS weave pattern. In one embodiment, all of the PS weft yarns are intrinsic weft pair yarns including one “regular” binder pair member and one “binder top” weft pair member. The portion of the weft yarn path located between the MS and PS layers and formed by the binder top pair member is referred to as a “stiffening section” as it contributes to the CD stiffness of the fabric. U.S. Pat. No. 7,740,029 (Hodson et al.) discloses a papermakers fabric in which the weft yarns are arranged in groups of two or more and weave in adjacent side-by-side contact. There may be groups of weft yarns in between those weaving in side-by-side contact and these may have a differing weave path, or the paths may be the same.

It would therefore be advantageous to provide a forming fabric which offers the benefits of increased mechanical stability and CD stiffness in comparison with the known fabrics, without consequential disadvantages of undue increase in caliper or adverse effects on drainage or wear resistance, by improved weave patterns which are applicable as modifications to a wide variety of fabric structures.

### SUMMARY OF THE INVENTION

As used herein, the term “complementary yarns” refers to two or more yarns, which for industrial fabrics in general may be warp yarns or weft yarns, and which are interwoven in a fabric so as to form a pattern equivalent to that followed by a single yarn in one repeat of the fabric weave. Such pairs of yarns only interweave with one layer of the fabric, and the term does not include yarns which function as binder yarns, i.e. which tie two fabric layers together by interweaving with yarns from both layers. Each member of a pair of complementary yarns alternates positions with the other member of that pair at exchange points as they interweave such that, as one yarn ceases interweaving with one layer and passes from that layer to be carried between the MS and PS layers, it is replaced by the other member of the pair which continues the weave pattern in that surface. The complementary yarns continue to exchange positions across the entire length or width of the pattern so as to form an unbroken yarn path in one surface of the fabric. In the fabrics of the present invention, the complementary yarns are pairs of weft yarns.

Further, as used herein, the term “float” refers to that portion of a component yarn which, in one repeat of the fabric weave, passes over or under a group of other yarns without interweaving with them.

The present invention is based on the discovery that it is possible to use, in the machine side layer of fabrics including at least two systems of weft yarns, pairs of machine side layer weft yarns arranged as pairs of complementary yarns to complete the MS fabric weave structure. In other words, the members of each weft yarn pair cooperate together by alternating with each other between interweaving with the MS warp yarns and being carried in the interior of the fabric, to form the weave pattern of the MS and effectively double the number of weft on the MS surface. This doubles the yarn mass in the MS layer and increases certain of the mechanical properties of the fabric, including stiffness, stability, wear resistance and Centre Plane Resistance (CPR). This feature is described by Danby et al. in U.S. Pat. No. 7,426,944, and refers to a reduced drainage area located along a notional centre plane through the fabric that is caused by the presence of long internal yarn floats; these floats may be from either, or both, the warp or weft yarns. The reduced drainage area in this centre plane of the fabric tends to resist the flow of fluid through the fabric and thereby retard the very high initial impingement drainage that occurs at or near the point of impingement of the stock jet onto the fabric.

Doubling the number of weft yarns in the MS layer, without reducing the size of those yarns, will increase the caliper or thickness of the resulting fabric. Over time, forming fabric manufacturers have strived to reduce fabric caliper so as to minimize the water carrying capacity of the fabric. Thin fabrics carry less water and are less prone to marking the sheet when the fabric passes around rolls at high speed in the papermaking process, causing water retained in the interior voids of the fabric to be released and spray onto the sheet.

In the fabrics of the present invention, it is possible to decrease the size of the MS complementary weft yarns in comparison to those which have been previously used in similar designs which are not so constructed and thereby to decrease fabric caliper, while at the same time retaining the prominence of the weft yarns on the MS surface, and thus not sacrificing the abrasion resistance of the fabric. This is because the number of weft yarns used in the fabrics of the present invention is double that which would be used in comparable designs. Further advantages of the fabrics of the invention include the ability to provide for increased stiffness and greater center plane resistance, while the use of decreased size for the MS complementary weft yarns allows for selection of desired values for fabric properties including air permeability and elastic modulus.

In the fabrics of this invention, the complementary weft yarns do not interweave with any of warp yarns forming the PS layer, but instead they alternate between remaining in the MS layer where they interweave solely with the MS warp yarns, and being carried between the PS and MS layers. Thus, the fabric structure can be tied into any selected PS weave by means of either intrinsic weft binder yarns in the manner described by Seabrook et al. in U.S. Pat. No. 5,826,627, or intrinsic warp binder yarns in the manner described by Danby et al. in U.S. Pat. No. 7,426,944. There can be zero, one, two or three MS warp yarns below each exchange point, i.e. the location where the complementary yarn pair members exchange positions with each other as they interweave across the fabric pattern so as to form an unbroken yarn path on the MS fabric surface. The MS surface of the fabric may be comprised entirely of the complementary yarn pairs (i.e. 100% of the MS weft yarns are complementary pairs), or there may be one, two, three or more “regular” (i.e. non-complementary) MS weft in between each complementary pair. The intrinsic binder yarns, either as pairs of weft yarns or pairs of warp yarns, will also interweave in the MS layer, but in general are recessed away from the MS surface.

In a broad embodiment, the invention seeks to provide a multilayer industrial fabric, woven according to an overall repeating weave pattern and having a paper side layer with a paper side surface and a machine side layer with a machine side surface, the fabric comprising at least one set of warp yarns and at least one set of paper side layer weft yarns and at least one set of machine side layer weft yarns, wherein at least some of the machine side layer weft yarns comprise complementary weft yarn pairs, each complementary weft yarn pair comprising a first member and a second member, which alternate with each other at exchange points to interweave only with selected warp yarns in the machine side layer such that for each complementary pair, when the first member of the pair is in the machine side surface of the fabric, the second member of the pair is carried between the machine side layer and the paper side layer.

Optionally, the machine side layer weft yarns comprise complementary weft yarn pairs and single weft yarns, in which case a ratio of complementary weft yarn pairs to all the machine side layer weft yarns can be at least 1 to 4, preferably at least 1 to 2, and more preferably at least 3 to 4. Alternatively, all the machine side layer weft yarns can comprise complementary weft yarn pairs.

For the fabrics of the invention, the repeating weave pattern can comprise a design selected from a double layer design, a semi duplex design, an extra support double layer design, a triple weft design, a triple layer sheet support binder design, a triple layer warp tie design and a triple layer warp integrated sheet support binder design.

In some embodiments, the paper side layer and the machine side layer are bound together by pairs of intrinsic weft binder yarns, in which case preferably the repeating weave pattern comprises a design selected from a double layer design, a semi duplex design, an extra support double layer design, a triple weft design, and a triple layer sheet support binder design, more preferably a triple layer sheet support binder design.

In other embodiments, the paper side layer and the machine side layer are bound together by pairs of intrinsic warp binder yarns, in which case preferably the repeating weave pattern comprises a design selected from a double layer design, a semi duplex design, an extra support double layer design, a triple weft design, a triple layer warp tie design and a triple layer warp integrated sheet support binder design, more preferably a triple layer warp integrated sheet support binder design.

In the fabrics of the invention, preferably each exchange point is located over a number of warp yarns in the machine side layer selected from 0, 1, 2 and 3.

Preferably, the complementary weft yarn pairs are polymeric monofilaments constructed of a material selected from polyesters, polyamides and blends thereof, and polymer blends. More preferably, the material is a polyester selected from polyethylene terephthalate (PET), polybutylene terephthalate (PBT) and copolymers and blends thereof; or a polyamide selected from polyamide-6, polyamide-66, polyamide-6/10, polyamide-6/12; or a polymer comprising a blend of thermoplastic polyurethane and polyester.

In the fabrics of the invention, preferably each member of each complementary weft yarn pair has a cross-sectional shape selected from one of circular, elliptical, rectangular and square.

Although, as noted above, the invention is applicable to various industrial filtration fabrics, it is particularly advantageous for papermakers' forming fabrics.

### BRIEF DESCRIPTION OF THE DRAWINGS

The invention will now be described with reference to the drawings, in which

FIG. 1 is a plan view of a portion of one repeat of the PS surface of a fabric 100 according to a first embodiment of the invention;

FIG. 2A is a cross-sectional view along section line 2A-2A in FIG. 1;

FIG. 2B is a cross-sectional view along section line 2B-2B in FIG. 1;

FIG. 2C is a cross-sectional view along section line 2C-2C in FIG. 1;

FIG. 2D is a cross-sectional view along section line 2D-2D in FIG. 1;

FIG. 2E is a cross-sectional view along section line 2E-2E in FIG. 1;

FIG. 3 is an isometric view of the machine side surface of the fabric of FIG. 1;

FIG. 4 is an isometric view of the paper side surface of the fabric of FIG. 1;

FIGS. 5A to 5C are SEM photographs of the fabric of FIGS. 1 to 4;

FIG. 6 is a complete weave diagram of the fabric shown in FIGS. 1 to 5C;

FIG. 7 is a cross-sectional view through the weft yarns of a fabric woven according to a second embodiment of the invention; and

FIG. 8 is a weave diagram of the fabric shown in FIG. 7.

### DETAILED DESCRIPTION OF THE DRAWINGS

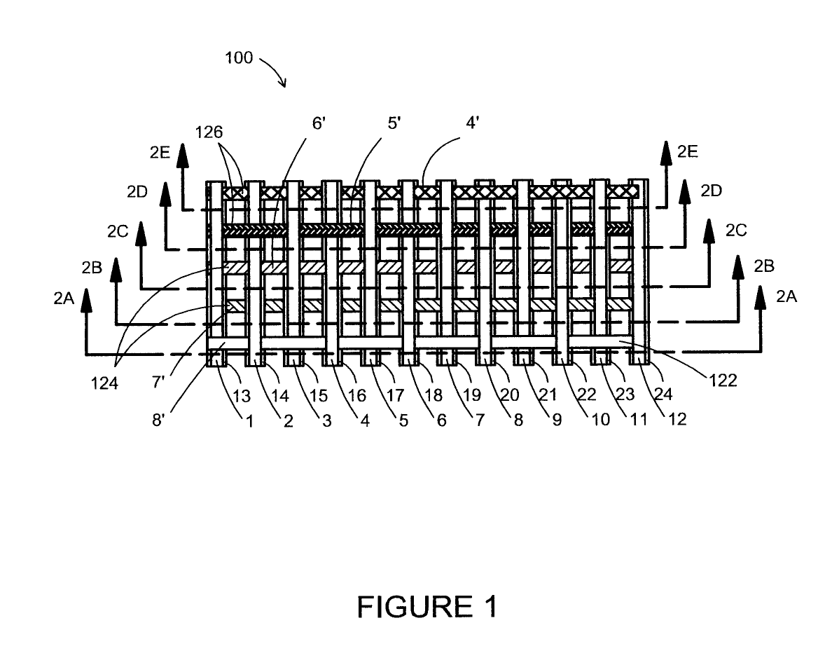

FIG. 1 is a plan view of the PS surface of a fabric 100 woven according to a first embodiment of the present invention, the weave diagram of the entire fabric being shown in FIG. 6, in which warp yarns 130 are identified across the top of the diagram and numbered individually as warp yarns 1 to 24, and weft yarns 110 are identified at the left of the diagram and numbered individually as weft yarns 1′ to 48′. In each of FIGS. 1 to 4, the individual warp and weft yarn numbering corresponds to the numbering in the weave diagram of FIG. 6.

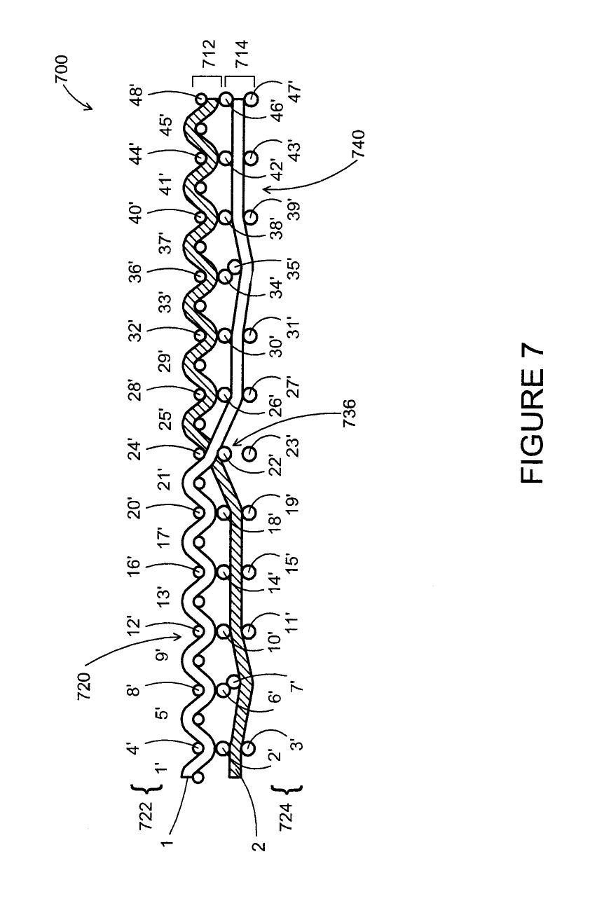

In the drawings, the sizes of some of the yarns, particularly the weft yarns 110 (FIGS. 1 to 4) and 710 (FIG. 7), have been enlarged for clarity and ease of understanding of the invention. Various factors relating to numeric and relative sizes of the different sets of yarns in the fabrics of the invention are discussed further below, including with reference to Table 1.

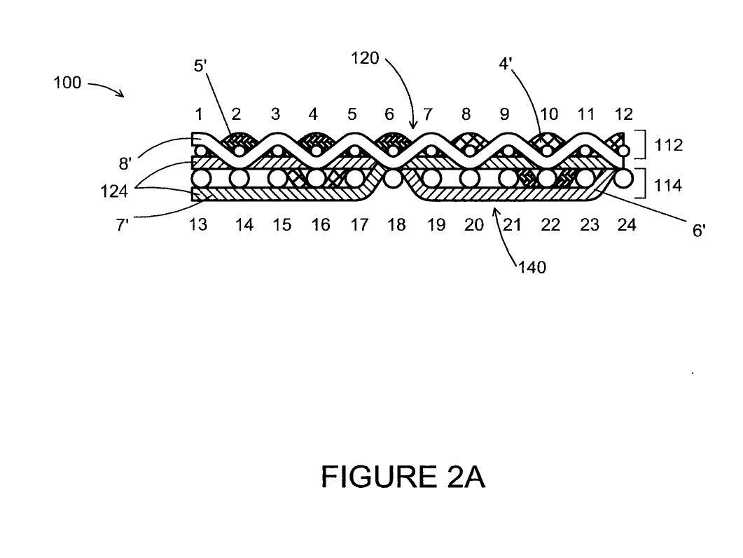

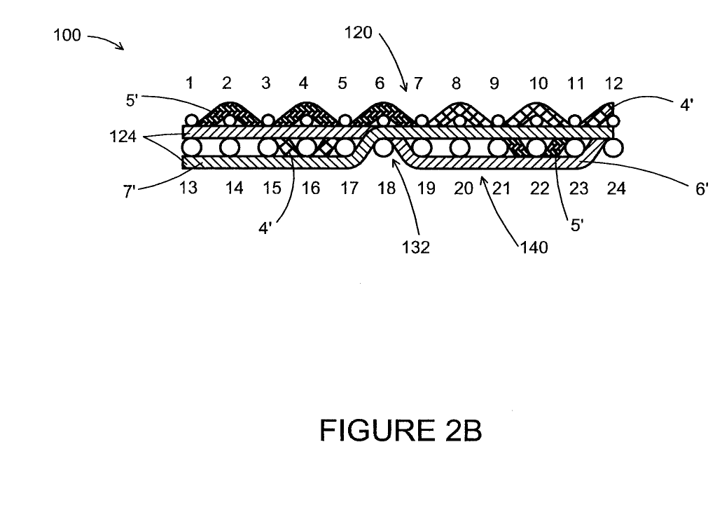

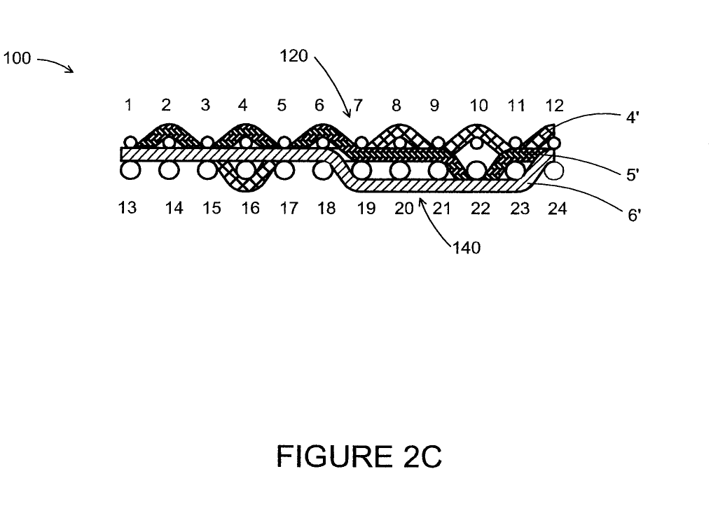

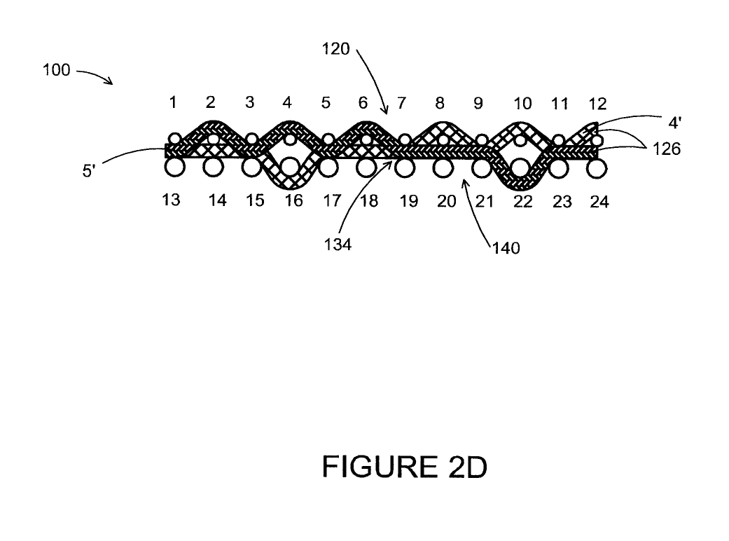

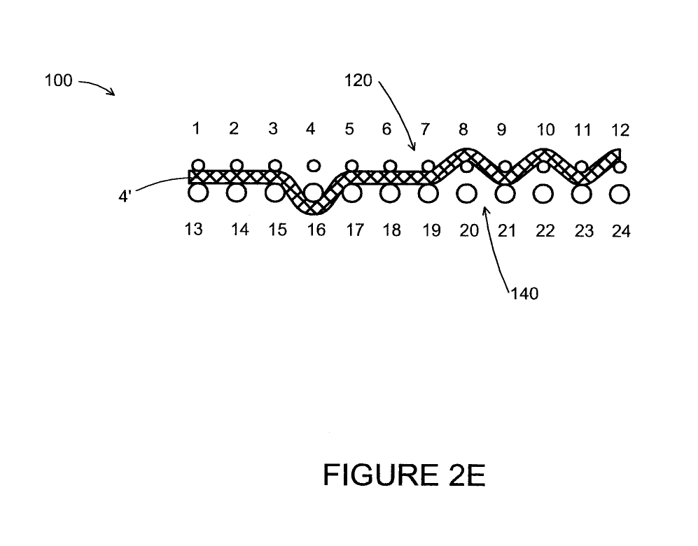

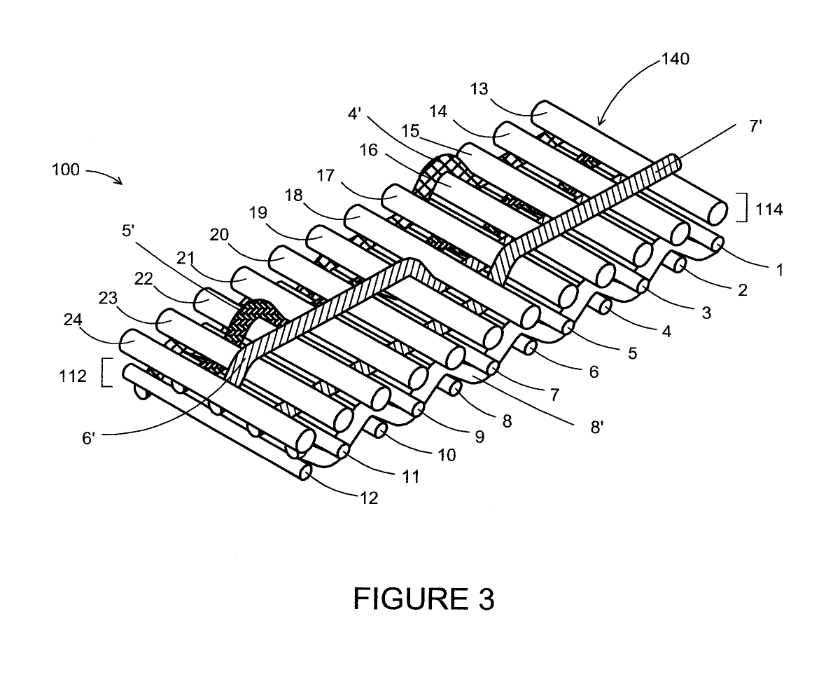

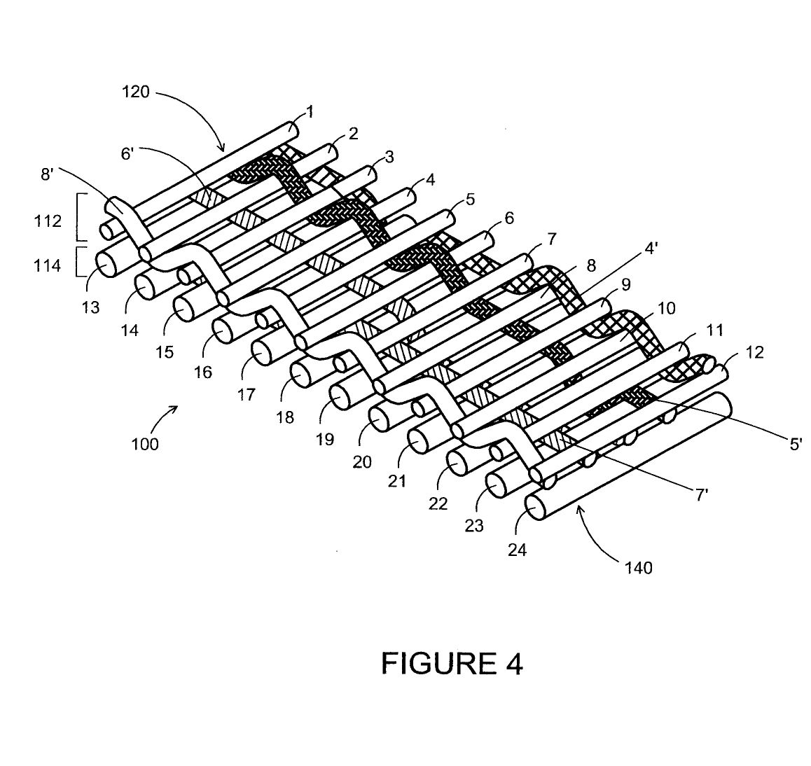

FIG. 1 shows five weft yarns 110, identified in the figure as weft yarns 4′ to 8′, forming a portion of a full repeat of the weave pattern of fabric 100, which is an SSB type composite forming fabric woven according to a 24-shed pattern, and which uses pairs of intrinsic weft binder yarns 126 to interconnect the PS layer 112 (see FIG. 4) and the MS layer 114 (see FIG. 3) and thereby integrate them into the complete composite fabric 100. In FIG. 1, the individual PS warp yarns 130 are identified by numerals 1 to 12, and the individual MS warp yarns 130 are identified by numerals 13 to 24. Five representative weft yarns are shown in FIG. 1 as follows. Weft yarn 8′ is a single PS layer weft yarn 122 which is interwoven only with the PS warp yarns 130, i.e. warp yarns 1 to 12. Weft yarns 7′ and 6′ are a pair of complementary weft yarns 124 interwoven only with the MS warp yarns 130, i.e. warp yarns 13 to 24. Weft yarns 4′ and 5′ are a pair of intrinsic weft binder yarns 126, each of which is interwoven with the PS layer warp yarns 1 to 12 and interlaced with the MS layer warp yarns 130, shown here as warp yarns 13 to 24. The paths of each of these weft yarns are shown in FIGS. 2A to 2E, and discussed in relation thereto below.

FIGS. 2A to 2E are each cross sectional views taken across the warp yarns of the fabric 100 shown in FIG. 1, along the respective section lines 2A-2A, 2B-2B, 2C-2C, 2D-2D and 2E-2E, to provide a representation of the relative position of the warp and weft yarns at locations corresponding to each of those section lines.

Referring first to FIG. 2A, this figure is a cross-sectional view of the fabric 100 shown in FIG. 1 along line 2A-2A, and showing the paths of five weft yarns to illustrate the principles of the present invention. As shown, the fabric 100 includes two layers of warp yarns 130; warp yarns 1 to 12 are arranged in the PS layer 112 and appear on the PS surface 120 of the fabric 100, and warp yarns 13 to 24 are arranged in the MS layer 114 and appear on the MS surface 140. FIG. 2A also shows a dedicated PS weft yarn 8′ which does not interlace with any of the MS warp yarns 130. The fabrics of the invention may include additional non-binding weft yarns, such as weft yarn 8′, and these may be provided in either, or both, the PS layer 112 or the MS layer 114 of fabric 100. A dedicated PS or MS layer weft yarn interweaves only with the warp yarns in that layer and does not interlace with any warp yarn from another layer of yarns. A pair of intrinsic weft binder yarns 126, shown here as 4′ and 5′, are interwoven with the PS warp yarns 1 to 12, each forming a portion of the PS surface 120; their arrangement is shown most clearly in FIG. 2D. FIG. 2A also shows a pair of complementary weft yarns 124, shown here as 6′ and 7′, which are located in the MS layer 114 of the fabric and which do not interweave with any of the PS layer warp yarns. The position of these yarns can be most clearly seen in FIG. 2B.

FIG. 2B is a cross-sectional view of the fabric 100 shown in FIG. 1, taken along line 2B-2B and showing the paths of a representative pair of complementary MS weft yarns 124, shown here as 6′ and 7′, as well as a pair of intrinsic weft binder yarns 126, shown here as 4′ and 5′. The complementary MS weft yarns 6′ and 7′ interweave only with the MS warp yarns 130, i.e. warp yarns 13 to 24. Starting from the left side of FIG. 2B, complementary weft yarn 6′ passes over MS warp yarns 13, 14, 15, 16, 17 and 18, and beneath PS warp yarns 1, 2, 3, 4, 5 and 6 without interweaving with them, and then exchanges position with complementary weft yarn 7′ at exchange point 132, and passes between MS warp yarns 18 and 19, thereafter being located on the MS surface 140 of MS layer 114. Similarly, complementary weft yarn 7′ passes under MS warp yarns 13, 14, 15, 16 and 17, then over warp yarn 18 where it exchanges position with weft yarn 6′ at exchange point 132. Complementary weft yarn 7′ then floats over MS warp yarns 19, 20, 21, 22 and 23 beneath PS warp yarns 7, 8, 9, 10, 11 and 12 without interweaving with them. At MS warp yarn 24, complementary weft yarns 6′ and 7′ exchange positions at the next exchange point 132 (not shown) and repeat the same pattern. Thus, the two complementary weft yarns 6′ and 7′ exchange positions at exchange points 132 (not shown) at the left and right sides of the figure where the pattern repeats, and at exchange point 132 over MS warp 18. Thus it can be seen that both the first and second members of the complementary weft yarns 6′ and 7′ remain in the MS layer 114 and between the MS layer 114 and the PS layer 112, and when the first member of the pair (e.g. 7′) is in the MS surface 140 of the fabric, the second member of the pair (e.g. 6′) is carried within the fabric.

As can be seen from FIG. 2B, the complementary weft yarns 6′ and 7′ together combine to interweave only with the MS warp yarns, i.e. yarns 13 to 24, cooperating to create an over 5/under 1 pattern. It can be appreciated that the long floats of these two weft yarns on the MS surface of the fabric will contribute to the wear resistance of this layer and thus the service life of the fabric. The arrangement also doubles the number of weft yarns in this layer and increases the cross-machine direction (CD) stiffness of the final fabric. These complementary weft yarns 124 can be of any desired cross-sectional shape or size that would be suitable for the intended application of the final fabric but they are preferably the same size as any dedicated MS weft yarns such as may be used in the MS layer of the fabric. As noted above, where all the MS weft yarns are provided as pairs of complementary weft yarns, their size can be significantly reduced, by as much as at least 30%, from the size which would generally be required for single MS weft yarns. The path of one of these complementary weft yarns 6′, as described above in relation to FIG. 2B, is more clearly shown in FIG. 2C, which is a cross-sectional view taken along the line 2C-2C in FIG. 1.

As noted above, the two fabric layers 112 and 114 are tied together as an integrated structure by means of intrinsic weft binder yarns 126. Various possible arrangements of these yarns are well known, and one suitable arrangement is shown most clearly in FIG. 2D, in a manner similar to that described in U.S. Pat. No. 5,826,627. In this figure, which is a cross-sectional view taken along the line 2D-2D in FIG. 1, it can be seen that the intrinsic weft binder yarn pair members 126, such as weft binder yarns 4′ and 5′, are interwoven with some of the PS warp yarns 1 to 12 so as to form part of the PS surface 120 of the fabric 100. The weft binder yarns 4′ and 5′ exchange positions at an exchange point 134 which, in this instance, is beneath PS warp 7 and above MS warp 19 so that, beginning from the left side of the figure, intrinsic weft binder yarn 5′ forms a plain weave on the PS surface 120 of the fabric 100, passing under warp yarn 1, over warp yarn 2, under warp yarn 3, over warp yarn 4, under warp yarn 5 and over warp yarn 6. Weft binder yarn 5′ then exchanges position with weft binder yarn 4′ at exchange point 134 and passes down into the MS layer 114 of the fabric 100 to float in the center plane between PS layer warp yarns 7, 8 and 9 and MS layer warp yarns 19, 20 and 21, and then interweave beneath MS warp yarn 22, thus binding the PS and MS fabric layers 112 and 114 together. Weft binder yarn 5′ then passes through the center plane of the fabric to cross after (to the right of) warp yarn 12, and then repeats the same pattern.

Also beginning at the left of FIG. 2D, weft binder yarn 4′ floats between the PS layer 112 and the MS layer 114 between PS layer warp yarns 1, 2 and 3 and MS layer warp yarns 13, 14 and 15. Weft binder yarn 4′ then passes beneath warp yarn 16 thereby binding the warp yarns 1 to 12 of PS layer 112 to the warp yarns 13 to 24 of MS layer 114. Weft binder yarn 4′ then floats between PS warp yarns 5, 6 and 7 and MS warp yarns 17, 18 and 19 to exchange positions with weft binder yarn 5′ over warp yarn 19 and beneath warp yarn 7 at exchange point 134 as described above, thus interconnecting MS fabric layer 114 to PS layer 112.

FIG. 2E, which is a cross-sectional view taken along the line 2E-2E in FIG. 1, shows the path of intrinsic weft binder yarn 4′ alone; as can be seen from this figure, from the left, weft binder yarn 4′ passes between the PS warp yarns 1, 2 and 3 and the MS warp yarns 13, 14, and 15, before interlacing with MS warp yarn 16, to bind the PS and MS layers 112 and 114 together. Thereafter weft binder yarn 4′ passes between PS warp yarns 5, 6 and 7, and MS warp yarns 17, 18 and 19, before passing up into the PS layer 112 to interweave with PS warp yarns 8, 10 and 12.

FIG. 3 is a perspective view of the MS layer 114 and PS layer 112 of the fabric 100 shown in FIG. 1, as seen looking onto the MS surface 140 of MS layer 114. In this figure, the intrinsic weft binder yarn pair members 4′ and 5′, the complementary weft yarn pair members 6′ and 7′ and the dedicated PS layer weft yarn 8′ are shown. FIG. 3 clearly shows the long MS float formed on the MS surface 140 of the fabric 100 by the complementary weft yarns 6′ and 7′. It can also be seen from this figure that, as one pair member, such as weft yarn 6′, appears in the MS surface 140 of the MS layer 114, the other pair member, weft yarn 7′, remains recessed between the PS and MS layers 112 and 114, where it floats between the two layers of warp yarns 130. At warp 18, complementary weft yarn 6′ passes up from the MS surface 140 and floats between the PS and MS layers 112 and 114, while the other complementary pair member, weft yarn 7′, passes down to the MS surface and continues the path commenced by weft yarn 6′. Thus it can be seen from FIG. 3 that the two complementary weft yarns 6′ and 7′ together combine to interweave only with the MS warp yarns 13 to 24, and together form a continuous under 5/over 1 pattern. It can also be seen that the first and second members of the pair remain in the MS layer 114 and between the MS layer 114 and the PS layer 112; and when the first member of the pair is in the MS surface 140 of the fabric, the second member of the pair is carried within the fabric.

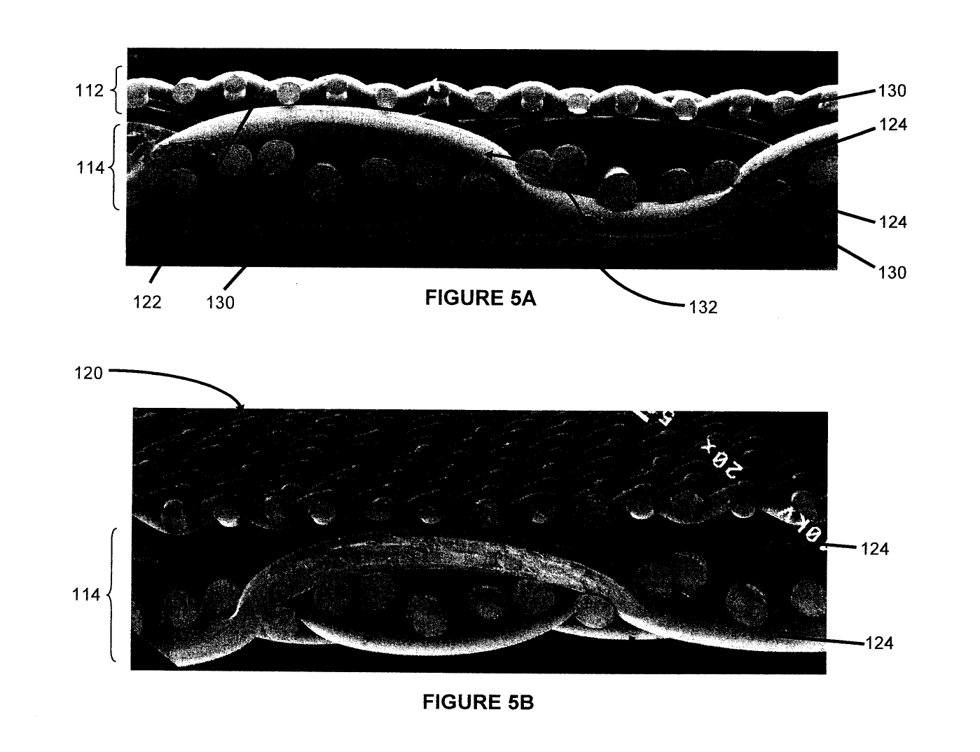

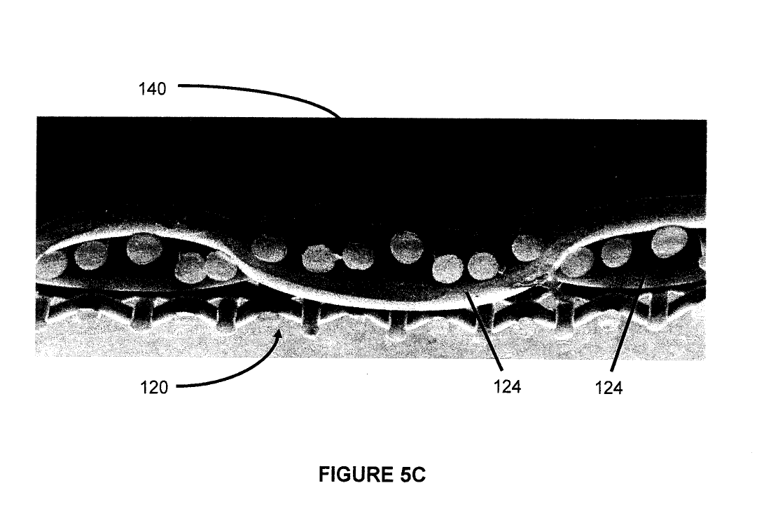

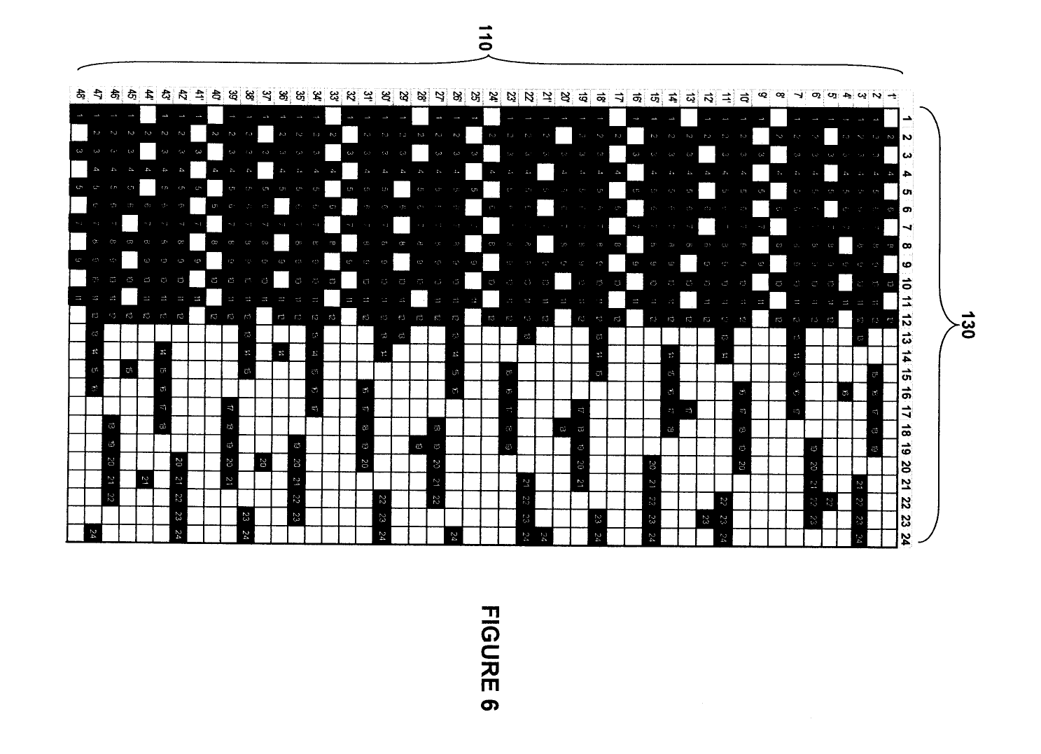

It can further be seen from FIG. 3 that the intrinsic weft binder yarn pair members, shown here as weft binder yarns 4′ and 5′, only interlace beneath single MS layer warp yarns, as at MS warp yarns 16 and 22, so as to tie the PS and MS fabric layers 112 and 114 together. This pattern is repeated throughout the fabric and can be seen more clearly with reference to FIG. 5C.

FIG. 4 is a perspective view of the PS layer 112 and the MS layer 114 of the fabric 100 shown in FIG. 1, and corresponding to the view in FIG. 3, but as seen looking at the PS surface 120 of the PS layer 112. In this figure, the intrinsic weft binder yarn pair members 4′ and 5′, the complementary weft yarn pair members 6′ and 7′ and the dedicated PS layer weft yarn 8′ are shown. FIG. 4 shows the interweaving of the intrinsic weft binder yarn pair members 4′ and 5′ with the PS layer warp yarns 1 to 12. FIG. 4 also shows the manner in which dedicated PS layer weft yarn 8′ interweaves only with the PS warp yarns 1 to 12. It can also be seen that the complementary weft yarn pair members 6′ and 7′ interlace only with the MS layer warp yarns 13 to 24 and do not interweave with any of the PS layer warp yarns 1 to 12. Thus, reading from left to right, it can be seen that weft yarn 4′ passes beneath PS warp yarns 1, 2 and 3 (but above MS layer warp yarns 13, 14 and 15), then passes beneath MS warp yarn 16 to tie the PS and MS layers 112 and 114 together, continues beneath PS warp yarns 5, 6 and 7, and then interweaves with warp yarns 8, 9, 10, 11 and 12 to form a portion of the PS layer 112. Similarly, weft yarn 5′ interweaves with warp yarns 1, 2, 3, 4, 5 and 6 before passing down beneath PS layer warp yarns 7, 8 and 9 (but above MS layer warp yarns 19, 20 and 21) and then passes beneath MS warp yarn 22 to bind the PS and MS layers 112 and 114 together. Weft yarn 5′ then continues to float between PS warp yarns 11 and 12 and MS layer warp yarns 23 and 24 before repeating the pattern. Complementary weft yarn 6′ floats between the PS layer warp yarns 1 to 6 and the MS layer warp yarns 13 to 18 before passing down to the MS layer 114 between warp yarns 18 and 19; it passes beneath MS layer warp yarns 19 to 23, before passing up and in between the PS and MS layers 112 and 114 to repeat the pattern. Similarly, complementary weft yarn 7′ passes beneath MS layer warp yarns 13 to 17, passes between warp yarns 17 and 18 and then floats between the PS and MS layers 112 and 114, passing above warp yarns 18 to 24 and beneath PS layer warp yarns 6 to 12. Thus it can be seen from FIG. 4 and the previous figures that, as one pair member such as 6′ forms a portion of the MS surface 140 of the MS layer 114, the other pair member 7′ remains recessed between the PS and MS layers 112 and 114 where it floats between the layers of warp yarns.

Further, it will be apparent to those skilled in the art that there may be zero, one, two, three, or more non-binding weft yarns such as weft yarn 8′, between each pair of intrinsic weft binder yarns such as weft binder yarns 4′ and 5′. In addition, it will also be apparent that there may be similar dedicated MS weft yarns in the fabric which are positioned between the pairs of complementary weft yarns, between the intrinsic weft yarn binder pair members, or at other locations as would be appropriate.

Referring now to FIGS. 5A to 5C, these are SEM photographs of a fabric 100 of the invention. FIG. 5A is a cross-sectional view of part of the fabric 100, showing the paths of a pair of MS complementary weft yarns 124, as they interweave with the MS warp yarns 130, in forming the MS layer 114, but without interweaving with the PS warp yarns 130 in the PS layer 112. The photograph shows one repeat of the weave pattern of the fabric 100, and the exchange point 132 where the pair of complementary weft yarns 124 exchange positions with each other.

FIG. 5B is a perspective cross-sectional view of a part of the same fabric 100 of the invention, showing the PS surface 120 of the PS layer 112, in which the PS weft yarns 122 (see FIG. 5A) interweave with only the PS warp yarns 130, to contribute to the plain weave pattern of the PS layer 112, and the intrinsic binder weft yarns 126 (as shown in FIG. 2D) interweave with the PS warp yarns 130 and the MS warp yarns 130 to contribute to the plain weave pattern of the PS layer 112 and to bind the PS and MS layers 112 and 114 together. In the MS layer, the paths of a pair of complementary weft yarns 124 are shown, as in FIG. 5A.

FIG. 5C is a perspective cross-sectional view of part of the same fabric 100 of the invention, showing the MS surface 140, in which the pairs of complementary weft yarns 124 interweave with the MS warp yarns 130, in the over 5, under 1, pattern described above, particularly with reference to FIG. 2B.

The fabric 100 shown in each of FIGS. 1 to 4 and in the photographs of FIGS. 5A to 5C is woven according to the weave pattern shown in FIG. 6.

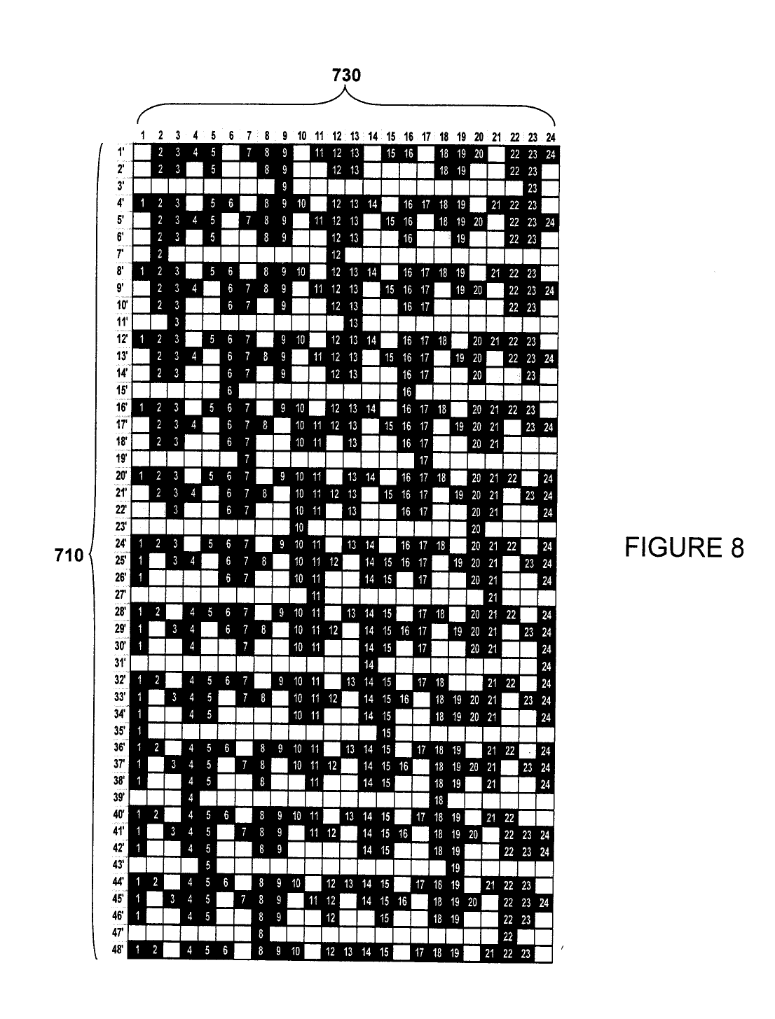

FIG. 7 is a cross-sectional view through the weft yarns of a fabric 700 woven according to a second embodiment of the invention, in one repeat of the weave pattern, the weave diagram for the entire fabric 700 being shown in FIG. 8, in which warp yarns 730 are identified across the top of the diagram and numbered individually as warp yarns 1 to 24, and weft yarns 710 are identified at the left of the diagram and numbered individually as weft yarns 1′ to 48′. In FIG. 7, the individual warp and weft yarn numbering corresponds to the numbering in the weave diagram of FIG. 8.

In FIG. 7, the PS weft yarns 722, numbered individually as 1′, 4′, 5′ . . . 44′, 45′ and 48′, interweave with the warp yarns 730 to contribute to the PS surface 720 of the PS layer 712. The MS complementary weft yarns 724 interweave with the warp yarns 730, in the general manner shown with respect to the complementary weft yarns 124 in FIGS. 1 to 6. The PS layer 712 and the MS layer 714 of the fabric 700 are tied together by pairs of the intrinsic warp binder yarns 730, a typical pair being shown in FIG. 7 as warp binder yarns 1 and 2. The first member of the pair, warp binder yarn 1, interweaves with PS weft yarns 1′, 5′, 9′, 13′, 17′ and 21′, before passing from the PS surface 722 at exchange point 736, and then remains in the MS layer 714, interlacing at a single location with the lower member of one pair of MS complementary weft yarns 724, i.e. with weft yarns 34′ and 35′, but otherwise passing between the two members of the pairs of MS complementary weft yarns 724. The second member of the pair of warp binder yarns, i.e. warp binder yarn 2, follows a corresponding path, first passing between the pairs of MS complementary weft yarns 724 and interlacing at a single location with the lower member of one pair, i.e. with weft yarns 6′ and 7′, and then exchanging positions with warp binder yarn 1 at exchange point 736, and then passing up into the PS layer 712 to contribute to the weave pattern of the PS surface.

FIGS. 7 and 8 illustrate that it is possible to employ the complementary weft yarns of the invention in a warp integrated sheet support (WISS) binder type fabric. In such fabrics, all of the warp yarns are binder yarns, i.e. they form the PS layer 712 and contribute to the MS layer 714 while tying the two layers together. However, the invention is equally applicable to other warp tied fabrics which include additional warp yarns which are not binder yarns.

Similarly, in the embodiment shown in FIGS. 7 and 8, all the MS weft yarns are complementary weft yarn pairs; but the invention is equally applicable to warp tied fabrics which include additional single weft yarns in the MS layer.

The embodiments illustrated in FIGS. 1 to 8 are examples of specific weave designs (i.e. SSB fabrics in FIGS. 1 to 6, and WISS fabrics in FIGS. 7 and 8) to which the present invention can be applied. However, the use of the complementary weft yarns of the invention will be applicable to many variants of such designs, depending on the expected environmental conditions and the intended end use of the fabrics.

It is not necessary that the complementary MS weft pair members be of the same size, shape or material constitution as the PS weft yarns 110, 710. The complementary weft yarns can be larger or smaller than the PS weft yarns; in certain instances, for example where fabric caliper is particularly important, it may be advantageous to downsize these weft yarns so that they contribute less to the fabric thickness. It may also be advantageous to use as complementary weft yarns monofilaments formed from one of the various polyesters, such as polyethylene terephthalate (PET) or polybutylene terephthalate (PBT), or polyamides, such as polyamide-6, -66, -6/10, -12 and so on, or their respective blends or copolymers thereof, such as are known and would commonly be used in the industrial textile arts so as to maximize the wear life of the fabric; yarns formed from a blend of polyester and thermoplastic polyurethane such as described in U.S. Pat. No. 5,169,711 or U.S. Pat. No. 5,502,120 may also be beneficial.

A sample fabric of the invention was woven according to the weave pattern of FIG. 6, and tested, and the properties of the sample fabric are provided in Table 1 below. For comparison purposes, a similar fabric was woven according to U.S. Pat. No. 5,826,627, using the same materials as the experimental fabric, and tested.

TABLE 1

| | Experimental | Comparison |
|---|---|---|
| Property | Fabric | Fabric |
| PS Mesh & Knocking (/in.) | 73 × 79 | 74 × 83 |
| MS Mesh & Knocking (/in.) | 73 × 53 | 74 × 55 |
| PS MD Strand Diameter & Type | 0.13 mm PET | 0.13 mm PET |
| PS CD Strand Diameter & Type | 0.14 mm PET | 0.13 mm PET |
| Tie Strand Diameter & Type | 0.14 mm PET | 0.13 mm PET |
| MS Mesh & Knocking (/in.) | 73 × 53 | 74 × 55 |
| MS MD Strand Diameter & Type | 0.21 mm PET | 0.21 mm PET |
| MS CD Strand Diameter & Type | 0.26 mm PET | 0.25 mm nylon |
| Heatsetting Tension (p.l.i.) | 45 | 55 |
| Heatsetting Temperature (° F.) | 365 | 380 |

Fabric Properties: Experimental/Comparison

| | | |
|---|---|---|
| Length Increase (%) | 3.8 | 5.1 |
| Width Decrease (%) | 8.0 | 8.0 |
| Elastic Modulus (p.l.i.) | 8850 | 8100 |
| Lateral Contraction (% p.l.i.) | 0.0052 | 0.0056 |
| Air Permeability (on loom) | 380 | 475 |
| (cfm/ft²) | | |
| Caliper (in.) | 0.043 | 0.0331 |
| PS Crimp Differential (in.) | −0.0010 | −0.0008 |
| MS Crimp Differential | −0.0081 | −0.0051 |
| As Woven Caliper (in.) | 0.0435 | n/a |
| Total as woven Knocking (/in.) | 220 | 170 |
| Stiffness (MD/CD/Total) | 10.7/9.6/20.3 | 3.9/4.0/7.9 |

In Table 1 above, the PS & MS Mesh and Knocking are measured in the fabric following heatsetting at the tensions and temperatures indicated. Yarn sizes and processing conditions are as shown.

The data in Table 1 shows that Elastic Modulus of the experimental fabric is 10% higher than the comparison fabric that does not include the complementary weft yarn pairs of the present invention (8850 instead of 8100). This increase is likely due to the straighter path of the warp yarns in the fabric as a result of the yarn arrangement of the MS weft pair members. However, this increase in modulus is significant and was an unexpected benefit of the invention. However, the main benefit of the invention, that of increased fabric stiffness, is apparent from the data shown. The machine direction (MD) stiffness increased by 174% from 3.9 to 10.7 and the CD stiffness increased by 140% from 4.0 in the comparison fabric to 9.6 in the experimental which indicates that this fabric, which in almost all aspects is identical to the comparison fabric with the exception of the use of the complementary weft pairs in the MS, should be much stiffer when used on the papermaking machine. This should prevent or reduce problems such as creasing and similar issues associated with the dimensional stability of the fabric. Further, the MS crimp differential of the fabric of the invention is −0.0081 as compared to −0.0051 in the comparison fabric, indicating the weft yarns stand prouder from the MS surface of the fabric than those of the comparison fabric. This will prove beneficial with respect to the wear resistance properties of the fabric.

It will be noticed however that the air permeability of the experimental fabric is 20% lower than that of the comparison; this is due to the additional weft yarns in the MS surface. Further, although the caliper value of the comparison fabric is not provided, it is expected to be thinner than that of the experimental fabric. It is anticipated that both of these properties could be easily modified in the experimental fabric by replacing the MS weft yarns with smaller diameter yarns. This is not expected to adversely impact the wear resistance of the fabric due to the much higher wear volume present on the MS.

1. A multilayer industrial fabric, woven according to an overall repeating weave pattern and having a paper side layer with a paper side surface and a machine side layer with a machine side surface, the fabric comprising at least one set of warp yarns and at least one set of paper side layer weft yarns and at least one set of machine side layer weft yarns, wherein at least some of the machine side layer weft yarns comprise complementary weft yarn pairs, each complementary weft yarn pair comprising a first member and a second member, which alternate with each other at exchange points to interweave only with selected warp yarns in the machine side layer such that for each complementary pair, when the first member of the pair is in the machine side surface of the fabric, the second member of the pair is carried between the machine side layer and the paper side layer.

2. A fabric according to claim 1, wherein the machine side layer weft yarns comprise complementary weft yarn pairs and single weft yarns.

3. A fabric according to claim 2, wherein a ratio of complementary weft yarn pairs to machine side layer weft yarns is at least 1 to 4.

4. A fabric according to claim 3, wherein the ratio is at least 1 to 2.

5. A fabric according to claim 4, wherein the ratio is at least 3 to 4.

6. A fabric according to claim 1, wherein all the machine side layer weft yarns comprise complementary weft yarn pairs.

7. A fabric according to claim 1, wherein the repeating weave pattern comprises a design selected from a double layer design, a semi duplex design, an extra support double layer design, a triple weft design, a triple layer sheet support binder design, a triple layer warp tie design and a triple layer warp integrated sheet support binder design.

8. A fabric according to claim 1, wherein the paper side layer and the machine side layer are bound together by pairs of intrinsic weft binder yarns.

9. A fabric according to claim 8, wherein the repeating weave pattern comprises a design selected from a double layer design, a semi duplex design, an extra support double layer design, a triple weft design, and a triple layer sheet support binder design.

10. A fabric according to claim 9, wherein the repeating weave pattern comprises a triple layer sheet support binder design.

11. A fabric according to claim 1, wherein the paper side layer and the machine side layer are bound together by pairs of intrinsic warp binder yarns.

12. A fabric according to claim 11, wherein the repeating weave pattern comprises a design selected from a double layer design, a semi duplex design, an extra support double layer design, a triple weft design, a triple layer warp tie design and a triple layer warp integrated sheet support binder design.

13. A fabric according to claim 12, wherein the repeating weave pattern comprises a triple layer warp integrated sheet support binder design.

14. A fabric according to claim 1, wherein each exchange point is located over a number of warp yarns in the machine side layer selected from 0, 1, 2 and 3.

15. A fabric according to claim 1, wherein the complementary weft yarn pairs are polymeric monofilaments constructed of a material selected from polyesters, polyamides and blends thereof, and polymer blends.

16. A fabric according to claim 15, wherein the material is a polyester selected from polyethylene terephthalate (PET), polybutylene terephthalate (PBT) and copolymers and blends thereof.

17. A fabric according to claim 15, wherein the material is a polyamide selected from polyamide-6, polyamide-66, polyamide-6/10, polyamide-6/12.

18. A fabric according to claim 15, wherein the material is a polymer comprising a blend of thermoplastic polyurethane and polyester.

19. A fabric according to claim 1, wherein each member of each complementary weft yarn pair has a cross-sectional shape selected from one of circular, elliptical, rectangular and square.

20. A fabric according to claim 1, wherein the fabric is a papermakers' forming fabric.
